(19) United States
(12) Patent Application Publication
(10) Pub. No.: US 2026/0219970 A1
(43) Pub. Date: Jul. 30, 2026

(54) METHOD AND SYSTEM FOR PROVIDING AN ADAPTIVE APPLICATION PROGRAMMING INTERFACE (API) FRAMEWORK

(71) Applicant: JPMorgan Chase Bank, N.A., New York, NY (US)

(72) Inventors: Charitha CHINTAMREDDY, Hyderabad (IN); Sagar GADDAM, Hyderabad (IN); Narayana ISANAKA, Hyderabad (IN); Zachariah ANTONAS, London (GB)

(73) Assignee: JPMorgan Chase Bank, N.A., New York, NY (US)

(21) Appl. No.: 19/082,890

(22) Filed: Mar. 18, 2025

(30) Foreign Application Priority Data
Jan. 30, 2025 (IN) 202511007812

(51) Int. Cl. G06F 9/54

(52) U.S. Cl. CPC G06F 9/547

(57) ABSTRACT

A method and system to provide an adaptive application programming interface (API) framework are disclosed. The method includes generating an API store comprising an API configuration information received from a plurality of API providers, the API configuration information comprising a set of attributes associated with a plurality of APIs. The method also includes defining at least one function based on the API configuration information, the at least one function corresponds to a set of tasks to be executed. The method also includes executing a set of APIs corresponding to the set of tasks, the set of APIs are a subset of the plurality of APIs. The method also includes obtaining at least one response based on the execution of the set of APIs. Thereafter, the method also includes storing the at least one response in a response database.

### CROSS-REFERENCE TO RELATED APPLICATIONS

This application claims priority benefit from Indian Application No. 202511007812, filed on Jan. 30, 2025 in the India Patent Office, which is hereby incorporated by reference in its entirety.

### FIELD OF THE DISCLOSURE

This technology generally relates to an application programming interface (API) framework, and more particularly relates to a method and system for providing an adaptive application programming interface (API) framework.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

As for the development of software entities, there are different ways that are developed for providing communication between the two or more software entities. One of the ways for communication between the two software entities is an application programming interface (API). API is a set of rules, definitions and contracts that allow software entities to communicate. As per current usages, API-based architecture has become a trending method for modern software development. The API-based architecture allows different systems and applications to communicate and share data seamlessly.

During software development, API providers and API consumers manage an API framework for establishing communication. The API providers may create and manage APIs that allow developers to interact and integrate with the software, services, and data. The API consumers interact with an API to request, retrieve, or consume data and services provided by the API providers. The API consumers may spend excessive time and effort to develop code, test, and integrate it to connect with API providers. The current approach for software development requires each API consumer to implement the connectivity code separately, which leads to duplication, inconsistencies and increased maintenance costs. Further, this approach also makes it a cumbersome task to handle any changes in the API contract, resulting in increased downtime and frequent deployments. Furthermore, the lack of a standardized API contract and versioning strategy further complicates the software development and usage. Moreover, the API consumers need to handle different versions of the API and maintain backward compatibility, leading to additional complexity and potential issues. Further, for example, the existing solutions implementing the WINDOWS® OS patching with the current API framework require a lengthy and complex code. Further, each API consumer may have to develop different configuration set ups for integrating with their use cases.

Hence, in view of these and other existing limitations, there arises an imperative need to provide an efficient solution to overcome the above-mentioned limitations and to provide a method and system for providing an adaptive application programming interface (API) framework.

### SUMMARY

The present disclosure, through one or more of its various aspects, embodiments, and/or specific features or sub-components, provides inter alias, various systems, servers, devices, methods, media, programs, and platforms to provide an adaptive application programming interface (API) framework.

According to an aspect of the present disclosure, a method for providing an adaptive application programming interface (API) framework is disclosed. The method is implemented by at least one processor. The method may include generating, by the at least one processor, an API store comprising an API configuration information received from a plurality of API providers, the API configuration information comprising a set of attributes associated with a plurality of APIs. The method may include defining, by the at least one processor, at least one function based on the API configuration information, wherein the at least one function corresponding to a set of tasks to be executed. The method may also include executing, by the at least one processor, a set of APIs corresponding to the set of tasks, wherein the set of APIs are a subset of the plurality of APIs. The method may also include obtaining, by the at least one processor, at least one response based on the execution of the set of APIs. Thereafter, the method may include storing, by the at least one processor, the at least one response in a response database.

In accordance with an exemplary embodiment, the set of attributes may include at least one from among an API identifier, an API version information, an API uniform resource locator (URL), an input parameter, an output parameter, an API path, an API method, and an API status.

In accordance with an exemplary embodiment, the API method may correspond to performing at least one representational state transfer (REST) API call selected from among a GET call, a PUT call, a POST call, and a PATCH call.

In accordance with an exemplary embodiment, the API status may include at least one from among an active status, and an inactive status.

In accordance with an exemplary embodiment, the API store may include a plurality of tables to store the set of attributes.

In accordance with an exemplary embodiment, the defining may be performed based on a user input.

In accordance with an exemplary embodiment, the API configuration information may be selected in an at least one format from among an object notation data interchange format, a structured query language (SQL) format, an object notation data interchange SQL format, and an extensible markup language (XML) format.

In accordance with an exemplary embodiment, the defining may further include modifying at least one attribute from among the set of attributes.

According to another aspect of the present disclosure, a computing device configured to implement an execution of a method to provide an adaptive application programming interface (API) framework is disclosed. The computing device includes a processor; a memory; and a communication interface coupled to each of the processor and the memory. The processor may be configured to generate an API store comprising an API configuration information received from a plurality of API providers, the API configuration information comprising a set of attributes associated with a plurality of APIs. The processor may also be configured to define at least one function based on the API configuration information, wherein the at least one function corresponds to a set of tasks to be executed. The processor may also be configured to execute a set of APIs corresponding to the set of tasks, the set of APIs is a subset of the plurality of APIs. The processor may also be configured to obtain at least one response based on execution of the set of APIs and store the at least one response in a response database.

In accordance with another exemplary embodiment, the set of attributes may include at least one from among an API identifier, an API version information, an API uniform resource locator (URL), an input parameter, an output parameter, an API path, an API method, and an API status.

In accordance with another exemplary embodiment, the API method may correspond to performing at least one representational state transfer (REST) API call selected from among a GET call, a PUT call, a POST call, and a PATCH call.

In accordance with another exemplary embodiment, the API status may include at least one from among an active status, and an inactive status.

In accordance with another exemplary embodiment, the API store may include a plurality of tables to store the set of attributes.

In accordance with another exemplary embodiment, the defining may be performed based on a user input.

In accordance with another exemplary embodiment, the API configuration information may be selected in an at least one format from among an object notation data interchange format, a structured query language (SQL) format, an object notation data interchange SQL format, and an extensible markup language (XML) format.

In accordance with another exemplary embodiment, the defining may further include modifying at least one attribute from among the set of attributes.

According to yet another aspect of the present disclosure, a non-transitory computer-readable storage medium storing instructions to provide an adaptive application programming interface (API) framework is disclosed. The instructions include executable code which, when executed by a processor, may cause the processor to generate an API store comprising an API configuration information received from a plurality of API providers, the API configuration information comprising a set of attributes associated with a plurality of APIs; define at least one function based on the API configuration information, the at least one function corresponds to a set of tasks to be executed; execute a set of APIs corresponding to the set of tasks, the set of APIs is a subset of the plurality of APIs; obtain at least one response based on execution of the set of APIs; and store the at least one response in a response database.

In accordance with yet another exemplary embodiment, the set of attributes may include at least one from among an API identifier, an API version information, an API uniform resource locator (URL), an input parameter, an output parameter, an API path, an API method, and an API status.

In accordance with yet another exemplary embodiment, the API method may correspond to performing at least one representational state transfer (REST) API call selected from among a GET call, a PUT call, a POST call, and a PATCH call.

In accordance with yet another exemplary embodiment, the API status may comprise at least one from among an active status, and an inactive status.

In accordance with yet another exemplary embodiment, the API store may comprise a plurality of tables configured to store the set of attributes.

In accordance with yet another exemplary embodiment, the defining may be performed based on a user input.

In accordance with yet another exemplary embodiment, the API configuration information may be selected in an at least one format from among an object notation data interchange format, a structured query language (SQL) format, an object notation data interchange SQL format, and an extensible markup language (XML) format.

In accordance with yet another exemplary embodiment, the defining may further include modifying at least one attribute from among the set of attributes.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary computer system for providing an adaptive application programming interface (API) framework, in accordance with an exemplary embodiment of the present disclosure.

FIG. 2 illustrates an exemplary diagram of a network environment for providing an adaptive application programming interface (API) framework, in accordance with an exemplary embodiment of the present disclosure.

FIG. 3 illustrates an exemplary system for providing an adaptive application programming interface (API) framework, in accordance with an exemplary embodiment of the present disclosure.

FIG. 4 illustrates an exemplary method flow diagram for providing an adaptive application programming interface (API) framework, in accordance with an exemplary embodiment of the present disclosure.

FIG. 5 illustrates an exemplary high-level architecture for providing an adaptive application programming interface (API) framework, in accordance with an exemplary embodiment of the present disclosure.

FIG. 6 illustrates an exemplary low-level architecture of a system for providing an adaptive application programming interface (API) framework, in accordance with an embodiment of the present disclosure.

FIG. 7 illustrates an exemplary implementation of a system for providing an adaptive application programming interface (API) framework, in accordance with an embodiment of the present disclosure.

FIG. 8 illustrates an exemplary implementation of a system for providing an adaptive application programming interface (API) framework for WINDOWS® OS patching, in accordance with an embodiment of the present disclosure.

### DETAILED DESCRIPTION

Exemplary embodiments now will be described with reference to the accompanying drawings. The present application may, however, be embodied in many different forms and should not be construed as limited to the embodiments set forth herein; rather, these embodiments are provided so that this present application will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of the ordinary skilled in the art to which this present application pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the unit.

In the following description, for the purposes of explanation, numerous specific details have been set forth in order to provide a description of the disclosure. It will be apparent, however, that the present application may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a notable absence of systems or products that offer comprehensive and automated solutions for managing API configurations, execution, and response handling across complex environments involving multiple API providers and consumers. While existing technologies provide tools for managing individual API connections or workflows, they often fall short when applied to more dynamic and large-scale systems that require the integration of multiple APIs, real-time response handling, and configuration consistency. In environments where APIs need to interact with numerous external systems, these challenges include handling version updates, managing configuration drifts, synchronizing input/output parameters, and ensuring consistent performance across different platforms. Existing solutions typically lack a centralized system for managing these API interactions, requiring extensive manual coding, error handling, and ongoing maintenance to enable the APIs to continue to function as expected. Furthermore, they often do not offer real-time configuration monitoring and automated corrective actions, leaving systems vulnerable to inefficiencies or errors resulting from configuration changes or misalignment. As a result, there remains a significant gap in the ability of current solutions to provide an adaptive and scalable framework capable of handling complex API ecosystems. These gaps include the absence of automated configuration management, response storage, and real-time drift correction, which are necessary for the seamless execution of tasks across multiple APIs. Thus, the present application addresses this need by providing a flexible and adaptive API framework that automates the management, execution, and response handling of APIs.

The present disclosure solves the aforementioned problems by providing a method and system for providing an adaptive application programming interface (API) framework. In the present disclosure, the system initially generates an API store comprising an API configuration information received from a plurality of API providers, the API configuration information comprising a set of attributes associated with a plurality of APIs. Further, the system defines at least one function based on the API configuration information, the at least one function corresponds to a set of tasks to be executed. Further, the system executes a set of APIs corresponding to the set of tasks, the set of APIs are a subset of the plurality of APIs. Further, the system receives at least one response based on the execution of the set of APIs. Thereafter, the system stores the at least one response in a response database.

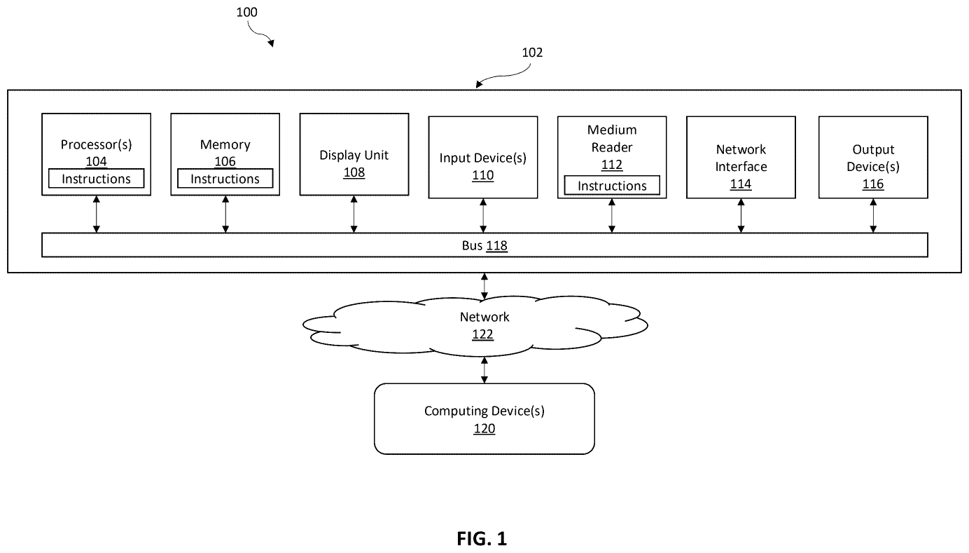

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, digital optical disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, BLUETOOTH®, ZIGBEE®, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

An additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to provide an adaptive application programming interface (API) framework.

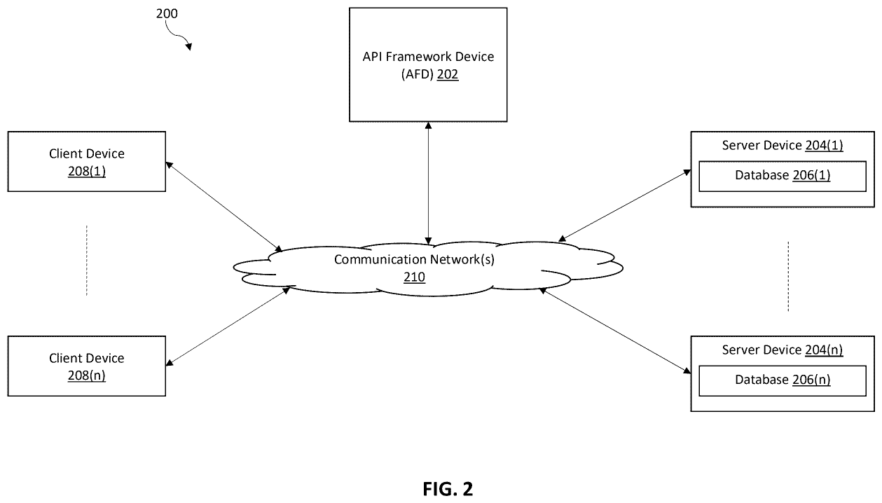

Referring to FIG. 2, a schematic of an exemplary network environment 200 to provide an adaptive application programming interface (API) framework is illustrated. In an exemplary embodiment, the method is executable on any networked computer platform, such as, for example, a personal computer (PC).

The method to provide an adaptive application programming interface (API) framework may be executed by an API framework device (AFD) 202. The AFD 202 may be the same or similar to the computer system 102 as described with respect to FIG. 1. The AFD 202 may store one or more applications that may include executable instructions that, when executed by the AFD 202, cause the AFD 202 to perform desired actions, such as to transmit, receive, or otherwise process network messages, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the AFD 202 itself, may be located in the virtual server(s) running in a cloud-based computing environment rather than being tied to one or more specific physical network computing devices. Also, the application(s) may be running in one or more virtual machines (VMs) executing on the AFD 202. Additionally, in one or more embodiments of this technology, virtual machine(s) running on the AFD 202 may be managed or supervised by a hypervisor.

In the network environment 200 of FIG. 2, the AFD 202 is coupled to a plurality of server devices 204(1)-204(n) that hosts a plurality of databases 206(1)-206(n), and also to a plurality of client devices 208(1)-208(n) via communication network(s) 210. A communication interface of the AFD 202, such as the network interface 114 of the computer system 102 of FIG. 1, operatively couples and communicates between the AFD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AFD 202, the server devices 204(1)-204(n), and/or the client devices 208(1)-208(n) may be coupled together via other topologies. Additionally, the network environment 200 may include for example, other network devices such as one or more routers and/or switches, which are well known in the art and thus will not be described herein. This technology provides several advantages including methods, non-transitory computer-readable media, and AFDs that efficiently implement the method to provide an adaptive application programming interface (API) framework.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The AFD 202 may be a standalone device or integrated with one or more other devices or apparatuses, such as, for example, one or more of the server devices 204(1)-204(n). In one particular example, the AFD 202 may include or be hosted by one of the server devices 204(1)-204(n), and other arrangements are also possible. Moreover, one or more of the devices of the AFD 202 may be in the same or a different communication network including, for example, one or more public, private, or cloud-based networks.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the AFD 202 via the communication network(s) 210 according to the hypertext transfer protocol (HTTP)-based and/or object notation data interchange protocol format. For example, this may be a JAVASCRIPT® object notation (JSON) format, although other protocols may also be used.

The server devices 204(1)-204(n) may be hardware or software or may represent a system with multiple servers in a pool, which may include internal or external networks. The server devices 204(1)-204(n) host databases or repositories 206(1)-206(n) that are configured to store data related to API framework.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within for example, a cluster architecture, a peer-to-peer architecture, virtual machines, or within a cloud-based architecture. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the AFD 202 via communication network(s) 210. Accordingly, the client devices 208(1)-208(n) may be, for example, mobile computing devices, desktop computing devices, laptop computing devices, tablet computing devices, or the like, that host chat, e-mail, or voice-to-text applications. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the AFD 202 via the communication network(s) 210 in order to communicate user requests and information. The client devices 208(1)-208(n) may further include, among other features, a display device, such as a display unit or touchscreen, and/or an input device, such as a keyboard.

Although the exemplary network environment 200 with the AFD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as, for example, the AFD 202, the server devices 204(1)-204(n), or the client devices 208(1)-208(n), may be configured to operate as virtual instances on the same physical machine. In other words, one or more of the AFD 202, the server devices 204(1)-204(n), or the client devices 208(1)-208(n) may operate on the same physical device rather than as separate devices communicating through communication network(s) 210. Additionally, there may be more or fewer AFDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

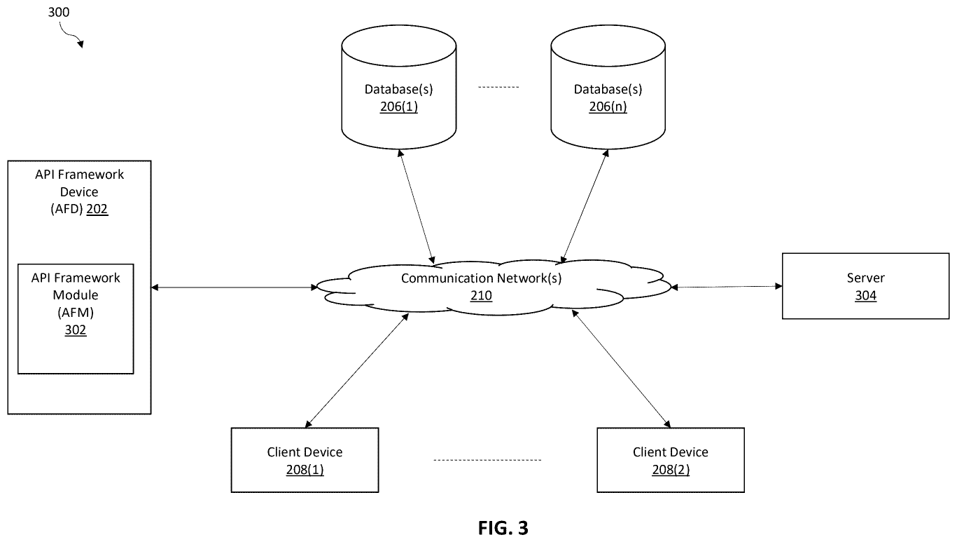

FIG. 3 illustrates a system diagram for implementing a method for providing an adaptive application programming interface (API) framework, in accordance with an exemplary embodiment.

As illustrated in FIG. 3, the system 300 may include an API framework device (AFD) 202 within which an API framework module (AFM) 302 is embedded, a server 304, a database(s) 206(1) . . . 206(n), a plurality of client devices 208(1) . . . 208(2), and a communication network(s) 210.

According to exemplary embodiments, the AFD 202 including the AFM 302 may be connected to the server 304, and the database(s) 206(1) . . . 206(n) via the communication network(s) 210, but the disclosure is not limited thereto. The AFD 202 may also be connected to the plurality of client devices 208(1) . . . 208(2) via the communication network 210, but the disclosure is not limited thereto. The database(s) 206(1) . . . 206(n) may include a rule database.

In an embodiment, the AFD 202 is described and shown in FIG. 3 as including the AFM 302, although it may include, for example, other rules, policies, modules, databases, or applications. As will be described below, the AFM 302 is configured to implement a method for providing an adaptive application programming interface (API) framework.

An exemplary system 300 for implementing a mechanism for providing an adaptive application programming interface (API) framework by utilizing the network environment of FIG. 2 is shown as being executed in FIG. 3. Specifically, a first client device 208(1) and a second client device 208(2) are illustrated as being in communication with the AFD 202. In this regard, the first client device 208(1) and the second client device 208(2) may be “clients” of the AFD 202 and are described herein as such. Nevertheless, it is to be known and understood that the first client device 208(1) and/or the second client device 208(2) need not necessarily be “clients” of the AFD 202, or any entity described in association therewith herein. Any additional or alternative relationship may exist between either or both of the first client device 208(1) and the second client device 208(2) and the AFD 202, or no relationship may exist.

Further, the AFD 202 is illustrated as being able to access one or more databases 206(1) . . . 206(n). The AFM 302 may be configured to access these repositories/databases for implementing a method to provide an adaptive application programming interface (API) framework. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the AFD 202 via broadband or cellular communication. These embodiments are merely exemplary and are not limiting or exhaustive.

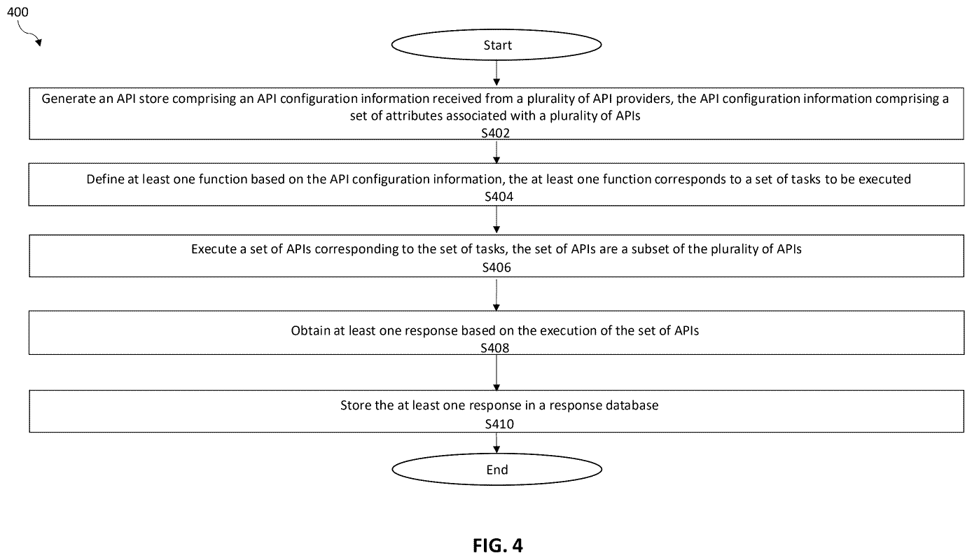

Referring to FIG. 4, an exemplary method 400 is shown for providing an adaptive application programming interface (API) framework, in accordance with an exemplary implementation.

As shown in FIG. 4, the method 400 begins following a need for providing an adaptive API framework between an API provider and an API consumer. The method 400 is implemented by at least one processor 104.

At step S402, the method 400 includes generating, by the at least one processor 104, an API store comprising an API configuration information received from a plurality of API providers, wherein the API configuration information comprises a set of attributes associated with a plurality of APIs.

In an embodiment, the API store may comprise a plurality of tables configured to store the set of attributes. The API store acts as a central repository (such as dataset) to centralize and standardize the API configuration information required to interface with a plurality of APIs provided by the plurality of API providers (such as external API providers).

In an embodiment, the configuration data (such as the API configuration information) may facilitate interaction between the system and the plurality of APIs. The API configuration information encompasses a set of attributes that define the operational parameters of each API. The set of attributes may include, but are not limited only to an API identifier, an API version information, an input parameter, an output parameter, an API path, an API method, and an API status. The API identifier(s) corresponds to identifiers associated with the API that facilitate in uniquely identifying each API. The API version information corresponds to information associated with the version of each API. The API path may indicate an endpoint or a uniform resource locator (URL) to access the API.

In an embodiment, the input parameter may correspond to data required by the API to process requests. The output parameter may correspond to data returned by the API in response to a request. The API method(s) may correspond to performing at least one representational state transfer (REST) API call selected from among a GET call, a PUT call, a POST call, and a PATCH call that may dictate the type of action being performed by the API. The API status may correspond to the status of the API. The API status may include at least one from among an active status, and an inactive status.

It will be appreciated by the person skilled in the art that storing the API configuration information in a centralized API store facilitates in managing and interacting with the multiple APIs. This centralized approach eliminates the need for consumers to individually configure or maintain connectivity with each API provider, as the system can retrieve and utilize the stored configuration attributes dynamically. Furthermore, the API store enables the framework to adapt to changes in API versions or attributes without requiring significant changes to the underlying application code at the consumer end. In effect, the API consumer(s) can seamlessly access and interact with the multiple APIs in a consistent and scalable manner, regardless of the complexity or variability of the external APIs being integrated.

In an embodiment, the API configuration information may be received from the API providers in at least one format selected from among an object notation data interchange format, a structured query language (SQL) format, an object notation data interchange SQL format, and an extensible markup language (XML) format.

The generated API store enables the system to accommodate the plurality of APIs with different configurations while maintaining a standardized (such as common) interface for consumers. The generated API store also enables future updates or modifications to the APIs to be handled efficiently, thereby reducing downtime and the likelihood of configuration errors during the deployment. The proposed solution is thus highly adaptable and capable of managing a diverse ecosystem of the plurality of APIs, thereby providing significant benefits in terms of scalability, ease of maintenance, and integration simplicity.

At step S404, the method 400 includes defining, by the at least one processor 104, at least one function based on the API configuration information, wherein the at least one function corresponds to a set of tasks to be executed.

In an exemplary embodiment, defining may refer to the process by which the processor 104 creates at least one function that will interact with the API or APIs based on the API configuration information. The API configuration information retrieved from the API store may include the set of attributes which may define how each API may operate.

In an exemplary embodiment, the defining may be performed based on an input from an API consumer. For example, a user may be presented with a user interface (UI) that enables accessing the API store. The user may access the API store using the UI and provide an input via the UI to define the at least one function, thus defining the set of tasks to be executed.

In an exemplary embodiment, the defining may further comprise modifying at least one attribute from the set of attributes. For example, the API consumer (such as a user) may access the stored set of attributes and modify (such as update, amend, delete, or add) attributes according to the requirement.

In an embodiment, the at least one function may refer to a logical unit within the API framework that is designed to execute a set of tasks utilizing the API configuration information from the API store. The set of tasks may include, for example, sending a request to retrieve data from an API, updating records through an API, or aggregating information across multiple APIs. The function is configured to handle the specific details of how the task will be executed, including formatting requests, managing input/output data, and invoking the correct API method (for example, GET, POST, PUT, and DELETE).

In an embodiment, each of the defined at least one function may be associated with the set of attributes stored in the API configuration information. For example, if the task involves retrieving user account information from multiple APIs, the function will be defined with the necessary parameters such as the API endpoints (for example paths), required input data (for example user ID), and expected output data (for example account balance or status). The at least one function facilitates in enabling that the set of tasks are executed in accordance with the operational constraints and capabilities of the plurality of APIs, as described in their configuration data.

In an exemplary embodiment, the at least one function may not be static but may be dynamically adaptable based on the API configuration information stored in the API store. It will be appreciated by the person with ordinary skills in the art that if the API configuration information changes (such as a change in API version or an adjustment to input and output parameters), the defined at least one function may be automatically updated or modified to reflect the new configuration without requiring manual intervention or significant changes to the consumer application code.

In an embodiment, the set of tasks to be executed by the function may range from basic operations, such as fetching data from a single API to more complex workflows that involve interacting with multiple APIs in sequence or in parallel. For example, the at least one function may retrieve data from one API, process that data, and then send it to another API for further action. The at least one function is thus responsible for orchestrating the workflow, which may help in necessary error checking, and formatting the data appropriately based on the API configuration information.

In an exemplary embodiment, the at least one function may also include logic to handle different scenarios, that includes the set of tasks such as retry in case of API failures, managing API rate limits, and validating input/output data to enable conformity with the expected API formats. The set of tasks may be executed in real-time or scheduled at predetermined intervals, depending on the use case and the specific requirements set by the API consumers.

At step S406, the method 400 includes executing, by the at least one processor 104, a set of APIs corresponding to the set of tasks, the set of APIs are a subset of the plurality of APIs.

In an embodiment, the execution may refer to the act of invoking and running specific API calls based on the API configuration information and the at least one function that has been defined.

In an embodiment, the set of APIs being executed may refer to a selection of the set of APIs from the plurality of APIs that are necessary for carrying out the set of tasks outlined by the API consumer. The set of tasks may include retrieving data, updating information, performing computations, or any other operation that requires interaction with the plurality of APIs. The set of APIs being executed is determined based on the defined at least one function. Further, each task from the set of tasks corresponds to at least one API or the set of APIs. For example, if the defined task is to gather user data from multiple sources, the processor 104 may need to execute the plurality of APIs across different platforms to retrieve that data.

In an embodiment, the set of tasks may be a subset of the plurality of APIs. The plurality of APIs refers to all the APIs that are available and stored in the API store. However, not all of the plurality of APIs will be invoked during a single execution cycle, but only the set of APIs that are relevant to the current task will be executed. For example, if a consumer is only interested in fetching account information, the processor 104 will execute the set of APIs related to account retrieval, rather than invoking all available APIs.

During the execution, the processor 104 may follow the API configuration information retrieved from the API store such that the correct API paths, methods (GET, POST, etc.), input parameters, and output handling procedures are used for each API call. For example, if the task requires fetching data from an API that uses a GET method, the processor will construct the appropriate request by attaching the necessary input parameters (such as an account ID) and sending the request to the API's endpoint as defined in the configuration. Similarly, for a POST or PUT method, the processor will send the required data payload (e.g., user information or update details) to the API.

In an exemplary embodiment, the execution process also involves handling responses from the APIs. Once the processor sends a request to an API, it waits for the response, which may contain the requested data or a confirmation that the task has been completed (such as an update being successfully applied). The response data is then processed by the processor 104 according to the function's defined parameters, and the results are either stored or passed to the next task in the workflow.

Additionally, the processor 104 may manage the complexities involved in API execution, such as error handling, API rate limits, authentication, parallel or sequential execution. According to error handling, if an API call fails (e.g., due to network issues, incorrect input data, or an API being unavailable), the processor may implement retry mechanisms or alternative logic to handle the failure gracefully. According to API rate limits many APIs impose rate limits that restrict the number of requests that can be made in a given time frame. The processor 104 enables that the execution of the set of APIs complies with these rate limits, potentially queuing requests or adjusting the execution timing to avoid violations. According to authentication, for APIs that require authentication (e.g., through API keys, OAuth tokens, etc.), the processor 104 checks that the proper credentials are included in each API request, as specified in the configuration. According to parallel or sequential execution, depending on the nature of the tasks and the defined function, the processor 104 may execute the APIs either sequentially or in parallel. For example, if the tasks are independent of each other, the processor may execute the APIs in parallel to reduce execution time. Conversely, if the tasks are inter-dependent (i.e., the output of one API is needed as input for another), the processor 104 will execute the APIs sequentially, such that each step is completed before moving to the next.

Once the API execution is complete, the processor 104 collects the responses and may trigger additional actions based on those responses. For example, the processor may aggregate data from the plurality of APIs, apply transformations to the data (for example, formatting or filtering), and then pass the results to a different system or store it.

At step S408, the method 400 includes receiving, by the at least one processor 104, at least one response based on the execution of the set of APIs.

In an exemplary embodiment, after successful execution of the set of APIs calls, the processor 104 may await and process the received responses based on execution of the set APIs.

Each API call from among the set of APIs call is associated with a response, which may include a variety of data types depending on the set of APIs and the set of tasks executed. The at least one response may include data payloads, such as user account information, transaction details, status updates, or other results produced based on execution of the set of APIs.

In an exemplary embodiment, the at least one response may vary in format, depending on the set of APIs being executed and its corresponding protocol. For example, the response may be formatted as JSON, XML, or other data formats. The processor 104 may be configured to parse the different formats based on the API configuration information stored in the API store. The API configuration information helps the processor accurately interpret and extract the necessary data from the received response.

In an exemplary embodiment, the processor 104 may be configured to handle different types of responses, such as success responses, error responses, and partial responses.

According to success responses, when the API successfully processes the request, the response may generally contain the requested data or a confirmation that the operation (such as updating or deleting a record) has been completed. The processor will extract the relevant information from the response and may pass it on to subsequent tasks, store it in a database, or display it to the consumer, depending on the specific use case.

According to error responses, in some cases, the API may return an error response due to issues such as invalid input data, authentication failure, or internal server errors. The processor must be able to recognize and handle these error responses by analyzing the HTTP status codes (e.g., 400 for bad requests, 401 for unauthorized access, or 500 for server errors) or specific error messages provided by the API. Based on the error type, the processor may retry the request, prompt the user to correct the input, or log the error for further investigation.

According to partial responses, some APIs may return partial data if the request involves a large dataset or if the API has paginated results. The processor must manage these partial responses by either requesting additional data (following pagination instructions in the response) or aggregating the partial responses to form a complete dataset.

Once a response is received, the processor 104 may be configured to verify that the response conforms to the expected structure as defined by the API's configuration. For example, it checks whether the necessary fields, such as specific data elements or status codes, are present and valid.

After validation, the processor 104 may be configured to extract data from the response. For example, if the API response includes a JSON object with the user information, the processor will extract fields such as “user_id,” “account_balance,” or “transaction_status” based on the pre-defined function parameters. The extracted data is then processed according to the task's requirements.

In an exemplary embodiment, some APIs from among the set of APIs being executed may not provide immediate responses, especially if they are handling long-running operations. In such cases, the API might return an acknowledgment of the request and later send a follow-up response once the task is complete. The processor 104 may be configured to manage these asynchronous responses, either by periodically polling the API for updates or by handling notifications or callbacks from the API when the operation finishes.

In another exemplary embodiment, if the task involves multiple API calls, the processor 104 may be configured to receive responses from several different APIs. In such scenario, the processor aggregates these responses, combining them into a single result set that can be used for further processing. For example, the processor 104 may combine data from multiple APIs to present a consolidated view of user activity across different services.

At step S410, the method 400 includes storing, by the at least one processor 104, the at least one response in a response database.

Upon receiving the at least one response from the set of APIs, the processor 104 proceeds to store the response in the response database for providing a persistent record of the data received from the set of APIs. It will be appreciated by the person skilled in the art that by storing the at least one response in the response database ensures that the data is preserved for future use, easily accessible for queries, and available for additional processing. The storing thus enhances the overall efficiency, reliability, and scalability of the system by reducing redundant API calls, enabling historical tracking, and supporting complex workflows that rely on data from the plurality of APIs.

In an exemplary embodiment, the stored response in the response database may be transmitted to at least one from among the plurality of API consumers and the response store for future reference.

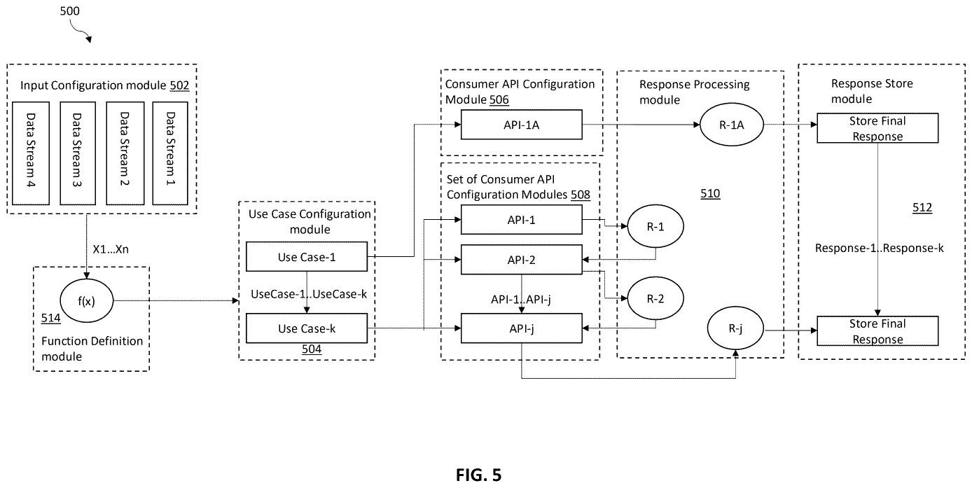

FIG. 5 illustrates an exemplary high-level architecture 500 for providing an adaptive application programming interface (API) framework, in accordance with an exemplary embodiment of the present disclosure. The high-level architecture 500 includes an input configuration module 502, a use case configuration module 504, a consumer API configuration module 506, a set of consumer API configuration modules 508, a response processing module 510, a response store module 512, and a function definition module 514.

The API configuration module 502 is responsible for providing data streams (such as data stream 1, data stream 2, data stream 3, and data stream 4) (alternatively referred to as an API configuration information) that will serve as input to the API framework. The data streams (such as data stream 1, data stream 2, data stream 3, and data stream 4) may include, but not limited only to SQL queries, JSON payloads, or other structured data formats that the API framework uses to communicate with external APIs. The API configuration information is received from a plurality of API providers, wherein the API configuration information comprises a set of attributes associated with a plurality of APIs.

Once the input data is configured, it is passed to the function definition module 514, which defines the at least one function based on the inputs (X1 . . . . Xn). Each function, represented as f(x), is formulated based on the set of attributes in the input configuration module 502. The function definition module 514 may involve complex workflows that require interacting with the plurality of APIs to accomplish a single objective, such as aggregating data or updating records across multiple systems. The defined functions may then be passed to the case configuration module 504 for further processing.

The use case configuration module 504 is where the use case (such as at least one task) is established based on the function definition module 514. The use case configuration module 504 includes various predefined use cases such as use case-1 . . . use case-k, and others. Each use case (such as at least one task) represents a specific operational scenario that requires the execution of the set of APIs. For example, a use case might represent the process of retrieving user account data from multiple systems or performing a multi-step workflow involving different APIs.

Next, the use cases interact with the consumer API configuration modules 506 and the set of consumer API configuration modules 508. The consumer API configuration module 506 corresponds to execution of API-1A. The set of consumer API configuration modules 508 corresponds to execution of the set of APIs (API-1, API-2 . . . . API-j). The consumer API configuration module 506 may handle a single API (for example API-1A) that is required for a specific use case. The set of consumer API configuration modules 508 may handle multiple APIs (e.g., API-1-i . . . and API-j), forming the set of APIs (API-1, API-2 . . . . API-j) to be executed.

Once the set of APIs (API-1, API-2 . . . . API-j) has been executed, the API framework proceeds to the response processing module 510. At the response processing module 510, the system obtains the at least one response from the set of APIs (API-1, API-2 . . . . API-j). Each of the at least one response from the executed set of APIs (API-1, API-2 . . . . API-j) may be represented by R-1A, R-1, R-2, R-j, and so on.

In an exemplary embodiment, as shown, the response R-1A corresponds to API-1A of the consumer API configuration module 506. Further, the response R-1 which corresponds to API-1 of the set of API configuration modules 508, is fed to API-2. Further, the response R-2 which corresponds to API-2 is fed to API-3. Similarly, the response R-j corresponds to API-J.

Once the at least one response has been processed, the final step is to store the results in the response store module 512. The stored at least one response is identified as response-1, response-k, and so on, corresponding to the processed outputs from each API call. In an exemplary embodiment, the final responses (such as response R-1A and response R-j) are stored.

In an embodiment, the response store module 512 archives the final processed responses (such as response R-1A and response R-j) from the set of APIs (API-1, API-2 . . . . API-j) involved in a particular use case. By storing the final responses, the API framework enables future retrieval of the data without the need to re-execute the same API calls. This approach improves efficiency, particularly in scenarios where the same data is required multiple times or where historical data needs to be accessed for auditing or analysis purposes.

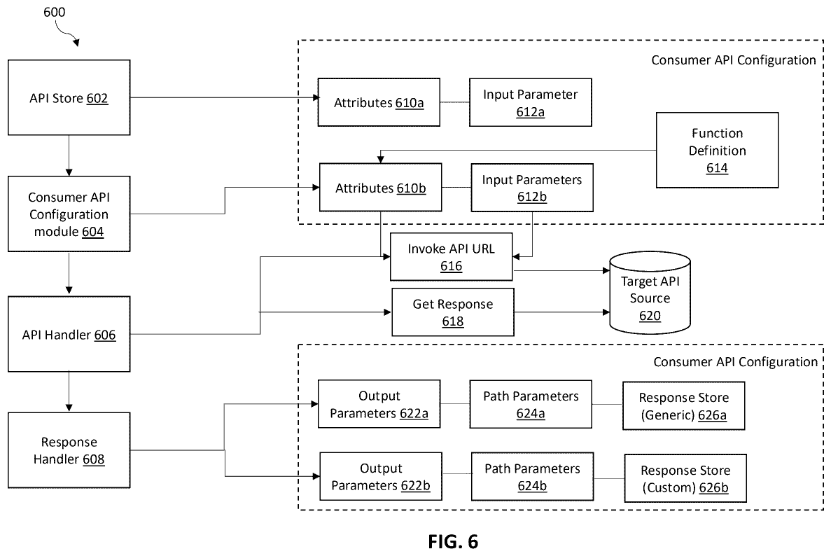

FIG. 6 illustrates an exemplary low-level architecture 600 of a system for providing an adaptive application programming interface (API) framework, in accordance with an embodiment of the present disclosure. The low-level architecture 600 includes an API store 602, a consumer API configuration module 604, an API handler 606, and a response handler 608.

The API store 602 may include the API configuration information received from the plurality of API providers, wherein the API configuration information may include the set of attributes (such as attributes 610a) associated with the plurality of APIs. The set of attributes (such as attributes 610a) may include at least one from among the API identifiers, the API version information, the input parameter 612a, the output parameter, the API path, an API method, and an API status. The API store 602 acts as a centralized repository where all API configuration information is stored. The API store comprises the plurality of tables configured to store the set of attributes.

The consumer API configuration module 604 represents the consumer's specific API usage and needs. The consumer API configuration module 604 works in conjunction with the API configuration information stored in the API store 602 such that API calls are made in accordance with the user's configuration. The consumer API configuration module 604 interfaces with the system to define how the consumer will interact with the plurality of APIs. The set of attributes stored in the API store 602 (such as Attributes 610a and Attributes 610b) are passed into the consumer API. The API store 602 comprises a plurality of tables configured to store the set of attributes. The consumer API configuration module 604 is configured to define how the system will use the plurality of APIs.

Once the consumer's specific API usage and needs are set, the system uses input parameters 612a and input parameters 612b to define the specific data required for execution of each API call. The input parameters 612a and the input parameters 612b include the input needed for the API requests, such as query strings, data payloads, and authentication tokens. Each API may have its own set of input parameters, such that the system may adapt to different requirements of each API.

The function definition module 614 facilitates in defining at least one function based on the API configuration information, wherein the at least one function corresponds to a set of tasks to be executed. The set of tasks are to be performed using the set of APIs (API-1, API-2 . . . . API-j). The function definition module 614 outlines the logical steps that the system must take when interacting with the set of APIs (API-1, API-2 . . . . API-j) based on the consumer's requirements. The at least one function may be as simple as retrieving data from a single API or as complex as executing a series of interconnected API calls across different platforms to achieve a specific outcome (e.g., combining data from different sources). The function definition module 614 is informed by the input parameters and attributes such that each task of the set of tasks is executed according to a predefined configuration.

The API handler 606 is responsible for executing the set of APIs (API-1, API-2 . . . . API-j) based on the configuration provided. The API handler 606 may take the defined at least one function and the input parameters and further construct the appropriate API requests. The API handler 606 may enable that the correct URL, method (GET, POST, PUT, DELETE), and input data are included for execution of the set of APIs (API-1, API-2 . . . . API-j).

The invoke API URL 616 is the step where the set of APIs (API-1, API-2 . . . . API-j) is executed. Based on the consumer's configuration, the system generates the API URL that may include the necessary path, and query parameters needed to execute the set of APIs (API-1, API-2 . . . . API-j). The system may send the request to the target API source 620 that the API URL corresponds to. The API URL may include the endpoint that the system interacts with, and it is constructed dynamically based on the inputs from the previous stages.

After the set of APIs (API-1, API-2 . . . . API-j) are executed at the target API source 620, the system enters into the Get response step 618, where it waits to obtain a response from the target API source 620. The response may include data requested by the API, such as user information, transaction details, or any other type of information based on the task being executed. The system processes the response and extracts the relevant data, preparing it for further handling.

The response handler 608 is responsible for processing the API response obtained from the target API source 620. The response handler 608 may validate if the obtained response conforms to the expected output format and extracts the necessary data based on the output parameters. The response handler 608 may also manage retries or handle cases where the response contains errors or is incomplete.

Once the response is processed, the system may identify output parameters 622a and output parameters 622b that define the data elements to be extracted from the API response. These parameters indicate what information is required from the API response (e.g., account balance, transaction status). Each output parameter may correspond to data that the API consumer expects to retrieve.

Path parameters 624a and path parameters 624b represent the API path configurations that dictate how the API URLs are constructed. The path parameters 624a and the path parameters 624b are used to dynamically build the API endpoint URLs by including the correct resource identifiers, query parameters, or other components necessary to form a valid API call.

The final stage involves storing the processed responses in a generic response store 626a or a customized response store 626b. The generic response store 626a holds standard responses that are applicable across multiple use cases or APIs, whereas the customized response store 626b is tailored for more specific or unique use cases where the response needs to be stored differently or requires special handling.

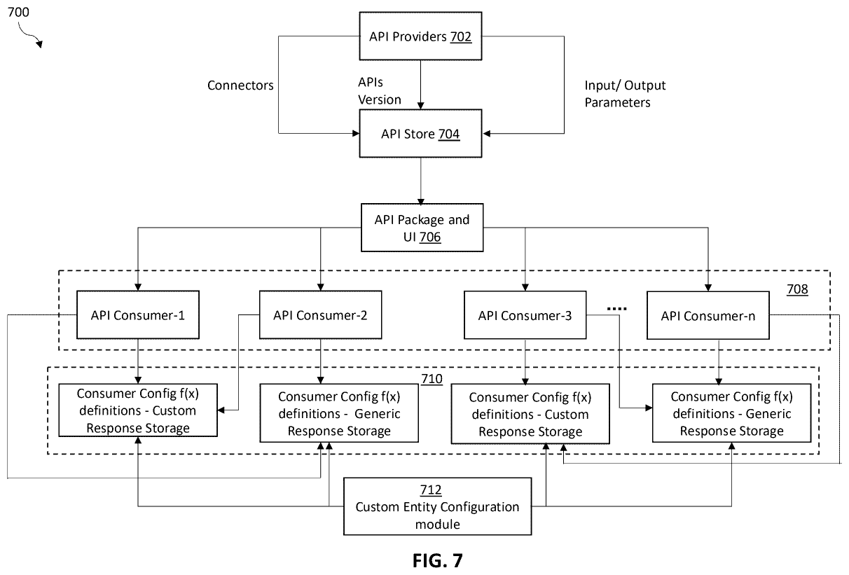

FIG. 7 illustrates an exemplary implementation 700 of a system for providing an adaptive application programming interface (API) framework, in accordance with an embodiment of the present disclosure. The implementation 700 may include an API provider 702, an API store 704, an API package and UI 706, API consumers 708, a consumer config f (x) definitions 710, and a custom entity configuration module 712.

In an embodiment, the API provider 702 are external entities that publish the plurality of APIs that may be consumed by the system. The plurality of API providers supply the plurality of APIs along with necessary metadata (such as the set of attributes). The set of attributes may include connectors that provide details about the connectivity required to access the plurality of APIs, such as authentication methods, network endpoints, and protocols. The set of attributes can include API version information that includes the API version information of the API being provided. The set of attributes may further include input parameters or output parameters that may include information about the expected input parameters (such as request payloads, query parameters) and the output data returned by the API (response payloads), respectively.

In an embodiment, the API store 704 may serve as a repository where the API configuration information and related set of attributes from the API provider 702 are stored.

In an embodiment, the API package and UI 706 is responsible for distribution and presentation of the API configurations to the API consumers 708. The API package and UI 706 enables the packaging of API configurations into reusable units that the API consumers 708 may easily access and integrate into their systems. The user interface (UI) provides a means for API consumers 708 to interact with the API configurations, allowing them to define their specific use cases, set input/output parameters, and manage their interactions with the plurality of APIs.

In an embodiment, the API consumers 708 may represent the different entities (referred to as API consumer-1, API consumer-2, API consumer-3, and API consumer-n) that utilize the plurality of APIs provided by the plurality of API providers. Each API consumer accesses and integrates the plurality of APIs based on their specific use cases (such as set of tasks). The API consumers 708 may be different applications, services, or systems that rely on the plurality of APIs to perform various tasks, such as retrieving data, updating records, or interacting with external systems.

In an embodiment, consumer config f (x) definitions 710 may enable each API consumer to be associated with a specific configuration that defines how they will interact with the APIs. The consumer config f (x) definitions 710 may further represent the function definitions for each API consumer, which determine the input parameters, or the output parameters and the logic required for their use cases. For example, consumer config f (x) definitions custom and consumer config f (x) definitions generic may represent how different consumer APIs may have customized or generic configurations based on their requirements.

In an embodiment, the API consumers may also have access to custom response stores and generic response stores, where the results of the API interactions are stored. These response stores may allow the consumers to save the at least one response returned by the APIs for future use or reference, such that the system does not need to repeatedly request the same data from the API providers. The custom response store is tailored for specific consumer requirements, while the generic response store applies more broadly to common or standardized use cases.

In an embodiment, the custom entity configuration module 712 may allow the API consumers to define custom entities or configurations that are specific to their use cases. The custom entity configuration module 712 provides the flexibility for consumers to tailor their API interactions according to their own business logic or workflow requirements. The custom configurations may include specific parameters, workflows, or response processing logic that are unique to a particular consumer's system.

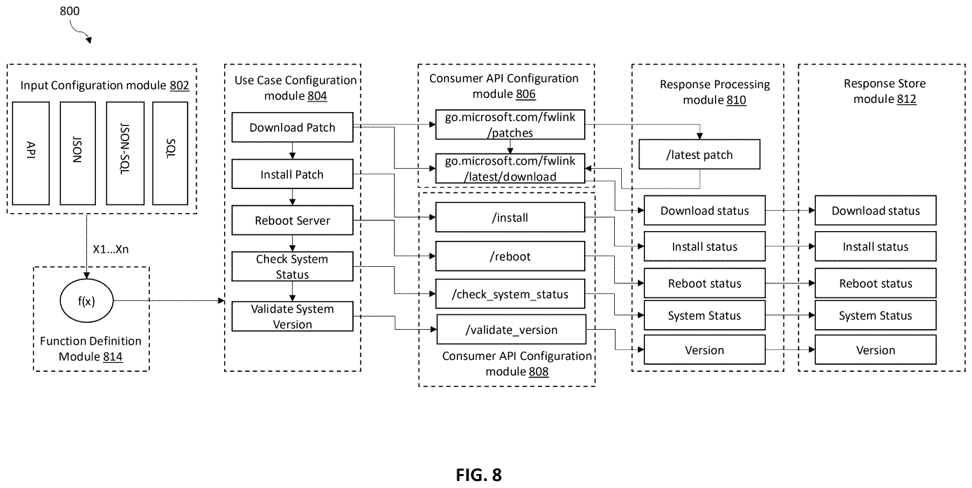

FIG. 8 illustrates an exemplary implementation of a system 800 for providing an adaptive application programming interface (API) framework for WINDOWS® OS patching, in accordance with an embodiment of the present disclosure. As shown in FIG. 8, system 800 comprises an input configuration module 802, a use case configuration module 804, a consumer API configuration module 806, a consumer API configuration module 808, a response processing module 810, a response store module 812 and a function definition module 814.

Those skilled in the art will appreciate that the above-listed components of the system 800 have similar functionality to those mentioned for the components of the system 500.

The system 800 provides an implementation of the adaptive API framework for WINDOWS® OS patching, which may help developers to reduce the effort and time to develop a code, a test, and an integration to connect between the API Consumers and the API provider, which may further reduce the maintenance effort. The present implementation of the system 800 may remove the need to handle different versions of the APIs and maintain a backward compatibility.

As shown in FIG. 8, input configuration module 802 enables dynamic input of entities from various sources such as SQL databases, JSON files, and APIs. Next, the function definition module 814 involves creating a function that groups a set of use cases to be executed for each entity. The entities can range from X1 to Xn, where ‘n’ represents the total number of entities. This function definition module ensures that each WINDOWS® machine undergoes the necessary patching steps in a systematic manner.

Next, the use case configuration module 804 represents a specific task achieved by executing one or more APIs. For WINDOWS® OS patching, the use cases may include for example, Find latest version and Download Patch: fetching the latest patches from the designated source, downloading the latest patch to install; Install Patch: installing the latest patches to the system; Reboot system: restarting the system to complete the patch installation; check system status: verifying the system's status post-reboot; validate system version: confirming that the system is running the expected version after patching. Each of these use cases may have a plurality of APIs. For example, the ‘Download Patch’ use case may involve two APIs: the first API fetches the list of the latest patches, and the second API downloads the selected patch.

Next, the consumer API configuration module 806 (and the set of consumer API configuration modules 508), based on the implementation, customizes the input and output configurations for each API used in the OS patching process. This ensures that each API call is tailored to the specific requirements of the patching steps as defined herein: 1). Fetch the latest patches from the designated source (go.microsoft.com/fwlink/patches); 2) Download the latest patch after fetching the patches (go.microsoft.com/fwlink/latest/download); 3) Execute the installation of patches (/install); 4) Initiate a system reboot (/reboot); 5) Assess the system's status post-reboot (/check_system_status); 6) Validate the system version to ensure the patch was applied successfully (/validate_version).

Next, the response processing module 810 handles the processing of API responses based on the output configurations set by the API consumer. The response processing steps for WINDOWS® OS patching may include, such as, but not limited to, download status: retrieves the status of the patch download; install status: retrieves the status of the patch installation; reboot status: retrieves the status of the system reboot; system status: retrieves the system's operational status; version: retrieves the system version post-patching.

Thereafter, the response store module 812 stores the responses for each use case based on the configured output values. The responses can be saved to a generic response store or a customized table as configured. Each use case has a final response that is stored from download patch to validate system version status. This ensures that all relevant data is captured and can be reviewed as needed.

Further, in an exemplary implementation, the WINDOWS® OS patching may be performed as shown in FIG. 6. The API store 602 may facilitate such as, but not limited to, at least one from among: listing all the APIs from various API providers; configuring the required parameters for input and output processing; and appending API to URL for a dynamic URL case, where API starts with/and not with http.

The table 1 lists all the APIs required to perform OS patching on a windows server:

TABLE 1

| api_id | API | method | Input | output_params |
|---|---|---|---|---|
| api_001 | catalog.update.microsoft.com/fwlink/patches | GET | | |
| api_002 | catalog.update.microsoft.com/fwlink/patches/download | GET | { ″payload″: | { |
| | | | { | “output_field”: |
| | | | ″version″:<version_to_{—} | ″ download |
| | | | download>, | _status”, |
| | | | | “output_value”: |
| | | | | { |
| | | | ″destination″:<path_to_{—} | “jsonpath”: |
| | | | download_file> | “<>”}, |
| | | | } | } |
| | | | } | |
| api_002 | /install | POST | { | { |
| | | | ″payload″:{ | “output_field”: |
| | | | “path”:″path_to_downl | ″ install |
| | | | oaded_file”} | _status”, |
| | | | } | “output_value”: |
| | | | | { |
| | | | | “jsonpath”: |
| | | | | “<>”}, |
| | | | | } |
| api_003 | /reboot | POST | | { |
| | | | | “output_field”: |
| | | | | ″ reboot |
| | | | | _status”, |
| | | | | “output_value”: |
| | | | | { |
| | | | | “jsonpath”: |
| | | | | “<>”}, |
| | | | | } |
| api_004 | /check_system_status | GET | | { |
| | | | | “output_field”: |
| | | | | ″ system |
| | | | | _status”, |
| | | | | “output_value”: |
| | | | | { |
| | | | | “jsonpath”: |
| | | | | “<>”}, |
| | | | | } |
| api_005 | /validate_version | GET | { | { |
| | | | ″payload″: { | “output_field”: |
| | | | ″expected_version″:″ver | ″ version”, |
| | | | sion″ | “output_value”: |
| | | | } | { |
| | | | } | “jsonpath”: |
| | | | | “<>”}, |
| | | | | } |

Next, as shown in Table 2, the function definition module 614 may include the following: a function with name “Windows OS Patching” is created and input_source_query is updated with a SQL query which returns the list of servers on which the use cases of the function will be executed. This function will be executed on request, so execution frequency is updated as None.

TABLE 2

| | | | | Execution |
|---|---|---|---|---|
| | Function | | | frequency |
| Function_id | name | Input_source_type | Input_source_query | cron |
| function_1 | Windows | SQL | select server from | None |
| | OS | | server_table | |
| | Patching | | | |
| function_2 | | | | |

Next, as shown in Table 3, the consumer API configuration module 604 may facilitate in creating at least one use case to perform WINDOWS® OS patching in a sequence using the api_id(s) from API store 602 table for the function mentioned in the function definition module 614 table above.

TABLE 3

| Function_{—} | use case | use case | | api_{—} | | output_{—} |
|---|---|---|---|---|---|---|
| id | name | id | api_id | sequence | Input | params |
| function_{—} | Download | function_{—} | api_001 | 1 | | |
| 1 | the patch | 1_001 | | | | |
| | file | | | | | |
| function_{—} | Download | function_{—} | api_002 | 2 | { “payload”: | { |
| 1 | the patch | 1_001 | | | {“version”:{ | “output_field |
| | file | | | | “jsonpath, | ”: |
| | | | | | “api_sequen | “download_s |
| | | | | | ce”:1, | tatus”, |
| | | | | | “type”:”str” | “output_valu |
| | | | | | }, | e”: { |
| | | | | | “destination” | “jsonpath”: |
| | | | | | :”/sharedfold | “$.records[*] |
| | | | | | er/download | .status”}, |
| | | | | | s” | } |
| | | | | | } | |
| | | | | | } | |
| function_{—} | Install the | function_{—} | api_002 | 0 | { | { |
| 1 | patch | 1_002 | | | “payload”:”/ | “output_field |
| | | | | | sharedfolder/ | ”: |
| | | | | | downloads/1 | “install_statu |
| | | | | | 0.1.1” | s”, |
| | | | | | } | “output_valu |
| | | | | | | e”: { |
| | | | | | | “jsonpath”: |
| | | | | | | “$.records[*] |
| | | | | | | .status”}, |
| | | | | | | “entity” : |
| | | | | | | {“server” : { |
| | | | | | | “jsonpath”: |
| | | | | | | “$.records[*] |
| | | | | | | .server”} } |
| | | | | | | } |
| function_{—} | Reboot | function_{—} | api_003 | 0 | | { |
| 1 | the | 1_003 | | | | “output_field |
| | machine | | | | | ”: |
| | | | | | | “reboot_statu |
| | | | | | | s”, |
| | | | | | | “output_valu |
| | | | | | | e”: { |
| | | | | | | “jsonpath”: |
| | | | | | | “$.records[*] |
| | | | | | | .status”}, |
| | | | | | | “entity” : |
| | | | | | | {“server” : { |
| | | | | | | “jsonpath”: |
| | | | | | | “$.records[*] |
| | | | | | | .server”} } |
| | | | | | | } |
| function_{—} | Wait for | function_{—} | api_004 | 0 | | { |
| 1 | machine | 1_004 | | | | “output_field |
| | to come | | | | | ”: |
| | back | | | | | “system_stat |
| | online | | | | | us”, |
| | | | | | | “output_valu |
| | | | | | | e”: { |
| | | | | | | “jsonpath”: |
| | | | | | | “$.records[*] |
| | | | | | | status”}, |
| | | | | | | “entity” : |
| | | | | | | {“server” : { |
| | | | | | | “jsonpath”: |
| | | | | | | “$.records[*] |
| | | | | | | .server”} } |
| | | | | | | } |
| function_{—} | Validate | function_{—} | api_005 | 0 | | { |
| 1 | the OS | 1_005 | | | | “output_field |
| | version | | | | | ”: “version”, |
| | post | | | | | “output_valu |
| | upgrade | | | | | e”: { |
| | | | | | | “jsonpath”: |
| | | | | | | “$.records[*] |
| | | | | | | .version”}, |
| | | | | | | “entity” : |
| | | | | | | {“server” : { |
| | | | | | | “jsonpath”: |
| | | | | | | “$.records[*] |
| | | | | | | .server”} } |
| | | | | | | } |

Next, the generic response store 626a may have the following responses as mentioned below Table 4:

TABLE 4

| Function_id | Use_case_id | Field | Value | Entity | Entity_value |
|---|---|---|---|---|---|
| function_1 | function_1_001 | download_status | SUCCESS | | |
| function_1 | function_1_002 | install_status | SUCCESS | server | server1 |
| function_1 | function_1_003 | reboot_status | SUCCESS | server | server1 |
| function_1 | function_1_004 | system_status | SUCCESS | server | server1 |
| function_1 | function_1_005 | Version | 10.1.1 | server | server1 |

The present disclosure provides numerous advantages as outlined below. The present disclosure provides a system and method for an adaptive API framework designed to streamline the integration and management of APIs across multiple providers and consumers. This method facilitates the configuration, execution, and management of APIs through dynamic input/output handling and automated response processing. By leveraging an API store, configuration management tools, and response storage, the present disclosure enables that the API interactions are performed consistently, reducing the burden on consumers to handle complex configurations manually. The present disclosure also provides a solution for efficiently managing configuration drift by continuously comparing live API configurations against predefined golden standards. Any discrepancies between the live configurations and ideal configurations are automatically corrected through an auto-healing mechanism, such that the system remains aligned with the golden configuration. This reduces system downtime and enhances reliability without requiring manual intervention. Moreover, the present disclosure enables organizations to adapt to new API versions and configurations without extensive rework with the help of its centralized API store and flexible configuration management. The present disclosure provides a system with customizable API configuration options, thereby allowing users to define specific workflows and use cases based on their individual requirements. By storing responses and configurations in dedicated storage components, the framework enables preserving the data for future use, for improving efficiency, and for reducing redundant API calls. Furthermore, the present disclosure enhances overall system performance by enabling the seamless integration of multiple APIs into complex workflows, thereby reducing the need for manual coding and debugging. The modular architecture allows for easy scalability, making it suitable for organizations with diverse API interaction needs. This approach ultimately drives better operational efficiency and reduces the cost of managing API ecosystem(s) while maintaining security and performance.

Although the present application has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the present application has been described with reference to particular means, materials, and embodiments, the present application is not intended to be limited to the particulars disclosed; rather the present application extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to provide an adaptive application programming interface (API) framework is disclosed. The instructions include executable code which, when executed by a processor 104, may cause the processor 104 to generate an API store comprising an API configuration information received from a plurality of API providers, the API configuration information comprising a set of attributes associated with a plurality of APIs; define at least one function based on the API configuration information, the at least one function corresponds to a set of tasks to be executed; execute a set of APIs (API-1, API-2 . . . . API-j) corresponding to the set of tasks, the set of APIs (API-1, API-2 . . . . API-j) is a subset of the plurality of APIs; obtain at least one response based on execution of the set of APIs (API-1, API-2 . . . . API-j); and store the at least one response in a response database.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing an adaptive application programming interface (API) framework, the method being implemented by at least one processor, the method comprising:
generating, by the at least one processor, an API store comprising an API configuration information received from a plurality of API providers, the API configuration information comprising a set of attributes associated with a plurality of APIs;
defining, by the at least one processor, at least one function based on the API configuration information, the at least one function corresponds to a set of tasks to be executed;
executing, by the at least one processor, a set of APIs corresponding to the set of tasks, wherein the set of APIs are a subset of the plurality of APIs;
obtaining, by the at least one processor, at least one response based on the execution of the set of APIs; and
storing, by the at least one processor, the at least one response in a response database.

2. The method of claim 1, wherein the set of attributes comprises at least one from among an API identifier, an API version information, an API uniform resource locator (URL), an input parameter, an output parameter, an API path, an API method, and an API status.

3. The method of claim 2, wherein the API method corresponds to performing at least one representational state transfer (REST) API call selected from among a GET call, a PUT call, a POST call, and a PATCH call.

4. The method of claim 2, wherein the API status comprises at least one from among an active status and an inactive status.

5. The method of claim 1, wherein the API store comprises a plurality of tables to store the set of attributes.

6. The method of claim 1, wherein the defining is performed based on an input from an API consumer.

7. The method of claim 1, wherein the API configuration information is selected in an at least one format from among an object notation data interchange format, a structured query language (SQL) format, an object notation data interchange SQL format, and an extensible markup language (XML) format.

8. The method of claim 1, wherein the defining further comprises modifying at least one attribute from among the set of attributes.

9. A computing device configured for providing an adaptive application programming interface (API) framework, the computing device comprising:
a processor;
a memory; and
a communication interface coupled to each of the processor and the memory,
wherein the processor is configured to:
generate an API store comprising an API configuration information received from a plurality of API providers, the API configuration information comprising a set of attributes associated with a plurality of APIs;
define at least one function based on the API configuration information, the at least one function corresponds to a set of tasks to be executed;
execute a set of APIs corresponding to the set of tasks, the set of APIs is a subset of the plurality of APIs;
obtain at least one response based on execution of the set of APIs; and
store the at least one response in a response database.

10. The computing device of claim 9, wherein the set of attributes comprises at least one from among an API identifier, an API version information, an API uniform resource locator (URL), an input parameter, an output parameter, an API path, an API method, and an API status.

11. The computing device of claim 10, wherein the API method corresponds to performing at least one representational state transfer (REST) API call selected from a GET call, a PUT call, a POST call, and a PATCH call.

12. The computing device of claim 10, wherein the API status comprises at least one from among an active status and an inactive status.

13. The computing device of claim 9, wherein the API store comprises a plurality of tables to store the set of attributes.

14. The computing device of claim 9, wherein the defining is performed based on a user input.

15. The computing device of claim 9, wherein the API configuration information is selected in an at least one format from among an object notation data interchange format, a structured query language (SQL) format, an object notation data interchange SQL format, and an extensible markup language (XML) format.

16. The computing device of claim 9, wherein the defining further comprises modifying at least one attribute from among the set of attributes.

17. A non-transitory computer readable storage medium storing instructions for providing an adaptive application programming interface (API) framework, the storage medium comprising executable code which, when executed by a processor, causes the processor to:
generate an API store comprising an API configuration information received from a plurality of API providers, the API configuration information comprising a set of attributes associated with a plurality of APIs;
define at least one function based on the API configuration information, the at least one function corresponds to a set of tasks to be executed;
execute a set of APIs corresponding to the set of tasks, the set of APIs is a subset of the plurality of APIs;
obtain at least one response based on execution of the set of APIs; and
store the at least one response in a response database.

18. The storage medium of claim 17, wherein the set of attributes comprises at least one from among an API identifier, an API version information, an API uniform resource locator (URL), an input parameter, an output parameter, an API path, an API method, and an API status.

19. The storage medium of claim 18, wherein the API method corresponds to performing at least one representational state transfer (REST) API call selected from a GET call, a PUT call, a POST call, and a PATCH call.

20. The storage medium of claim 18, wherein the API status comprises at least one from among an active status and an inactive status.
